(19) United States
(12) Patent Application Publication
(10) Pub. No.: US 2005/0286446 A1
(43) Pub. Date: Dec. 29, 2005

(54) Multi channel throughput enhancement

(75) Inventor: Simon Eric Miani Barber, San Francisco, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Devicescape Software Inc., Brisbane, CA (US)

(21) Appl. No.: 11/097,826

(22) Filed: Apr. 1, 2005

Related U.S. Application Data
(60) Provisional application No. 60/559,168, filed on Apr. 1, 2004.

(51) Int. Cl. H04J 3/06

(52) U.S. Cl. 370/278; 370/350; 370/503

(57) ABSTRACT

A wireless access point includes an ability to transmit signals over a plurality of channels and receive signals over the plurality of channels and have means for synchronizing transmission on a first channel to a first station and transmission on a second channel to a second station, such that acknowledgements are not expected from one of the first and second stations while transmitting frames to one or more of the first and second stations, means for transmitting over at least two of the plurality of channels simultaneously, means for receiving over at least two of the plurality of channels simultaneously. The number of channels might differ from implementation to implementation, but allows for simultaneous communication over the multiple channels with synchronization such that transmission on a channel is done while not expecting acknowledgements on any of the other channels. Synchronization can be done by ending transmission on a first channel and a second channel at the same time or within a predetermined short time period and/or organizing frames to be of similar size and beginning transmission at approximately the same time, so that transmissions end at the same time or within a predetermined short time period. Organizing frames to be of similar size can be done by breaking up packets as needed to get similar sized frames, using an 802.11 fragmentation facility, padding short packets as needed to get similar sized frames, and/or other methods. The access point might use NAV intervals and CTS-to-self signals to clear channels.

### CROSS-REFERENCE TO RELATED APPLICATIONS

This application claims priority from co-pending U.S. Provisional Patent Application No. 60/60/559,168 filed Apr. 1, 2004 entitled MULTI CHANNEL THROUGHPUT ENHANCEMENT which is hereby incorporated by reference, as if set forth in full in this document, for all purposes.

### BACKGROUND OF THE INVENTION

Wireless networks are useful for data transport and are becoming more common. A typical wireless network operating according to an 802.11 standard might operate at a stated data rate of 54 Mbps (megabits per second). Due to the overheads involved in the MAC layer (Media Access Control, such as packet framing, collision handling, sending ACKs, etc.), the end-user observed TCP throughput is typically found in the range of 22 Mbps, or up to around 30 Mbps if bursting is employed. Higher data rates are often desired and increased system throughput is often desired, especially in areas where there are many users.

A single channel of a typical 802.11 system sends data on the channel at a throughput of 54 Mbps. One approach manufacturers have tried for increasing throughput is to mount several 802.11 radios in a single access point and run them on different, nonoverlapping channels. In theory, this allows simultaneous operation on all the channels, and as long as multiple users are connected to the access point on different channels, they should be able to send and receive data simultaneously. This works if the radios are on different RF bands, but not as well if they are on different channels of the same band. Since there are only two RF bands in use for 802.11, this limits the technique to two radios per access point and often requires two sets of RF circuitry.

Multiple radios in the same band are problematic, largely due to the difference in power levels between transmitting and receiving. Typically, an access point or an end user will transmit a signal with a power between +10 dBm and +22 dBm (although other values within a few dB of this range are sometimes used). Typical end users are often at least a few feet away from the access point, and most frequently are farther away—often up to 50 or so feet away. The distance and the relatively poor antennas typically found in end user devices results in received signals at the ranging from approximately −50 dBm (for nearby users with good antennas) to −95 dBm. Received signals powers of −70 to −80 dBm would be very commonly observed.

When an 802.11 radio transmits in one channel, some of the transmitted signal spills over into adjacent channels, albeit at lower signal levels, and when a typical 802.11 radio receives signals in a channel, it might pick up some signal energy from just outside the channel's frequency range. Thus, the received signal includes energy from the transmitter in the channel of interest, energy that a transmitter might have spilled into the channel while transmitting on nearby channels, and energy that the receiver picked up from adjacent channels. Thus, it is important to have some adjacent channel filtering when possible, or to space the channels further apart.

“Adjacent channel rejection” is a measure of how much signals in adjacent channels interfere with the desired channel. Adjacent channel rejection is measured in dB of rejection. 10 dB of rejection would mean that a signal in an adjacent channel appears to be in the same channel, but at a level 10 dB lower than the desired signal. This adjacent channel rejection also exists, although at a lower level, for all channels within the same band.

Sometimes aggressive adjacent channel rejection is not possible or too expensive to implement. Another in-band interference effect that occurs in many RF designs is due to the radio having a front end amplifier that receives and filters the entire RF band it is designed to operate on. An automatic gain control (“AGC”) might be designed so that the RF signal is brought in at a constant level over the entire RF band, at whatever level the signal happened to be at when received. To keep costs down, the AGC is often designed to operate across the whole band and will have set its level to that of the highest signal in the band. If another signal is much lower, it will have been amplified much less than necessary and when decoded will contain a lot of noise, due to the insufficient level. This AGC effect means that a local transmitted signal in the band (often ˜100 dB stronger than a received signal) will cause any received signal to be completely lost due to noise, nonlinearity or lack of dynamic range in the further stages of processing after the AGC in the receiver.

FIG. 1 illustrates a spectrum of an 802.11 RF signal, including sidelobes. While the sidelobes are lower power than the main lobe in the desired channel, the sidelobe power from a locally transmitted signal might still be enough to swamp received signals in other channels that are at much lower power levels (often ˜100 dB). FIG. 2 illustrates adjacent channel interference. Note that each of the adjacent channels has sidelobes that spill over into the other channel. Often there are multiple sidelobes that span multiple channels, at progressively reducing levels.

Typical 802.11 radios have filters that give very high rejection of signals that are in different bands—precisely to allow dual band operation. This is possible at a price that is acceptable for these low cost products only because the bands are spaced far apart in the spectrum (e.g., 2.4 GHz and 5 GHz). Filters that give very high rejection ratios for signals that are close to each other (e.g., channels within the same band, especially neighboring channels) are very expensive. Thus, sharp filtering is often cost prohibitive and in the case where the transmitter has already mixed signals, direct filtering cannot be done to remove the undesired components.

The 802.11 MAC is a CSMA/CA MAC—this means that most data frames are acknowledged. When a unicast frame is sent from one station to another, the sender expects the recipient to sends an ACK frame back to the sender to indicate successful reception of the frame. The ACK frame is sent after a delay determined by the SIFS parameter. The SIFS delay is chosen in the 802.11 standard to allow the receiver just enough time to switch its radio from receive to transmit, and enough time for the transmitter to switch its radio from transmit to receive.

If two radios are operating on different channels within the same band and two clients are exchanging data with the access point, the wireless network might be used as indicated in the timing diagram shown in FIG. 3. There, the TX signals are those transmitted from the access point (“AP”) and the RX signals are those received by the access point. Channel A and channel B are used as examples, they might be channels 1 and 6, channels 1 and 10, or any other pair of channels (and these teachings can be expanded to more than two channels).

As illustrated there in FIG. 3, the wireless network is first occupied by a data frame 1 (containing “DATA1” data) sent by the AP on channel A. Shortly thereafter, another data frame 5 (containing “DATA2” data) is sent by the AP on channel B. Shortly after transmission of data frame 1 ends, the recipient will send an ACK frame 2. Because the AP itself is still sending data frame 5 on channel B, it will not hear the ACK (due to in-band interference from its own transmitter). Under typical conditions, data frame 5 is being transmitted at +10 dBm, while the ACK signal is received at −50 dBm. Either because of excessive in-band interference or because the receive AGC in the AP is set to too low a level due to the in-band signal from the AP's transmission of data frame 5, the AP misses ACK frame 2.

Since the AP does not hear ACK frame 2, the AP will attempt to retransmit the apparently lost data in a data frame 3. If the recipients of data frames 1 and 5 are far apart, they do not interfere with each other, so ACK frame 2 does not interfere with the other recipient's reception of data frame 5 and an ACK frame 6 for that data frame 5 is sent and received by the AP properly.

Next in the illustration, assume that a station sends the AP a data frame 7 (containing “DATA3” data) on channel B. Due to the AP's transmission of data frame 3 (the retransmission of data frame 1), data frame 7 will not be heard by the AP at all and then will not transmit a corresponding ACK frame, leading to further retransmissions.

Due to these and other interference effects when operating multiple radios in one AP on the same band, one typically observes the same end user throughput as if the AP had only a single radio. This is undesirable as it adds cost and complexity with little or no increase in throughput.

### BRIEF SUMMARY OF THE INVENTION

According to embodiments of the present invention, a wireless access point might include an ability to transmit signals over a plurality of channels and receive signals over the plurality of channels and have means for synchronizing transmission on a first channel to a first station and transmission on a second channel to a second station, such that acknowledgements are not expected from one of the first and second stations while transmitting frames to one or more of the first and second stations, means for transmitting over at least two of the plurality of channels simultaneously, means for receiving over at least two of the plurality of channels simultaneously. The number of channels might differ from implementation to implementation, but allows for simultaneous communication over the multiple channels with synchronization such that transmission on a channel is done while not expecting acknowledgements on any of the other channels. Synchronization can be done by ending transmission on a first channel and a second channel at the same time or within a predetermined short time period and/or organizing frames to be of similar duration and beginning transmission at approximately the same time, so that transmissions end at the same time or within a predetermined short time period. Organizing frames to be of similar size can be done by breaking up packets as needed to get similar sized frames, using an 802.11 fragmentation facility, padding short packets as needed to get similar sized frames, lowering the data rate used for short frames and/or other methods. The access point might use NAV intervals and CTS-to-self signals or other methods to clear channels.

### BRIEF DESCRIPTION OF THE DRAWINGS

FIG. 1 illustrates a spectrum of an 802.11 RF signal, including sidelobes.

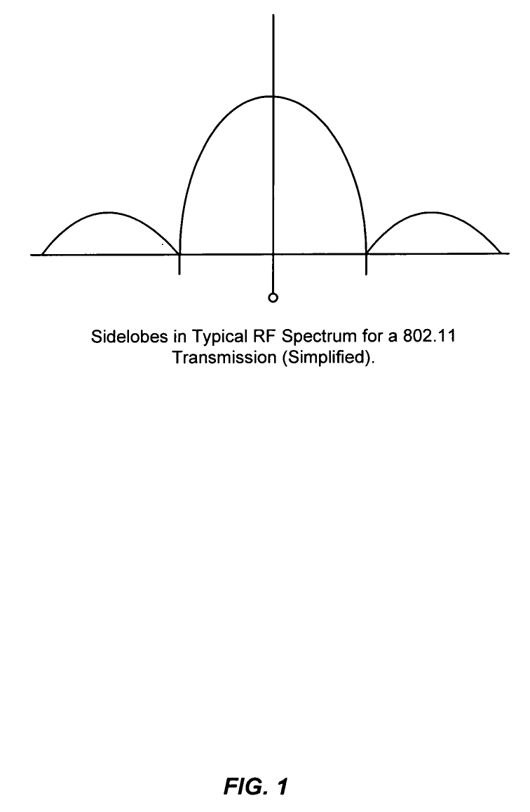

FIG. 2 illustrates adjacent channel interference.

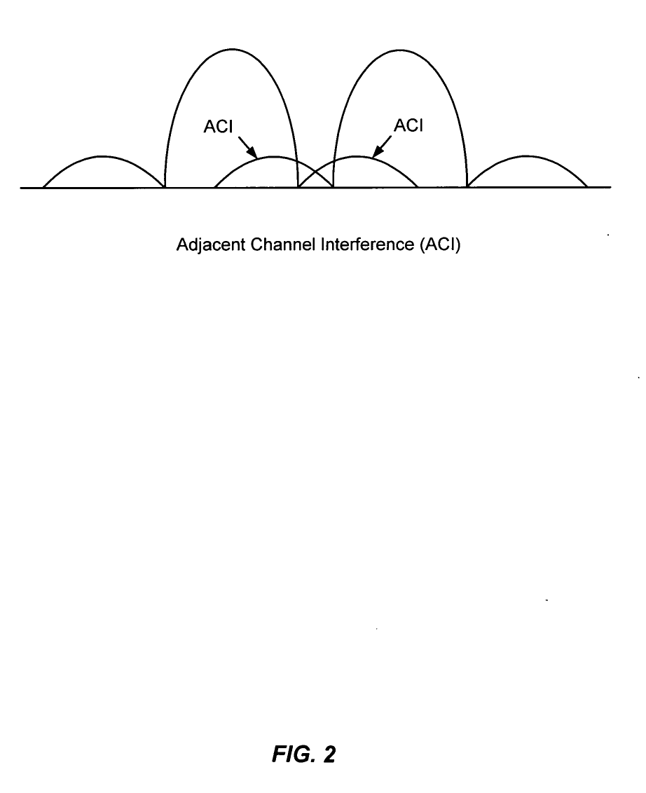

FIG. 3 is a timing diagram of transmissions from a conventional AP with two radios, wherein two radios are operating on different channels within the same band and two clients are exchanging data with the access point.

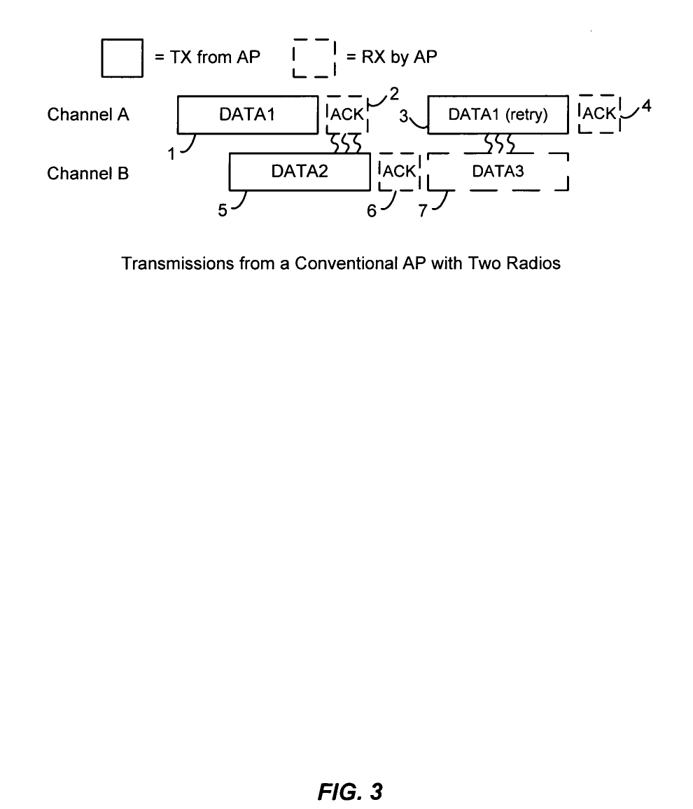

FIG. 4 is a timing diagram illustrating other aspects of embodiments of the invention, including simultaneous transmission of same length data.

FIG. 5 is a block diagram of a hardware embodiment.

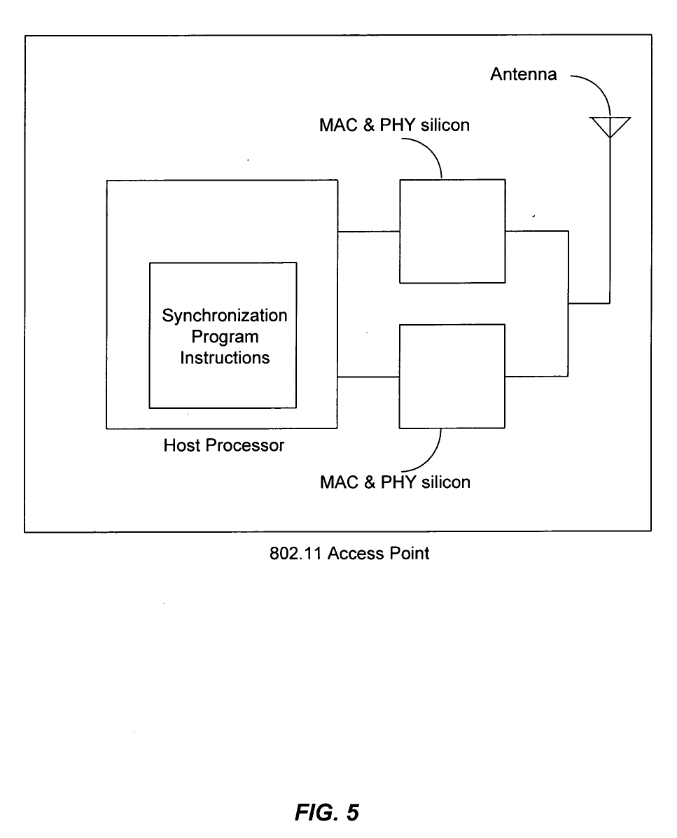

### DETAILED DESCRIPTION OF THE INVENTION

In embodiments of transceivers according to embodiments of the present invention, an access point operates on multiple channels and synchronizes multi-channel transmissions such that the AP is not transmitting on one channel when ACK frames or other frames are expected on another channel. For example, the AP would synchronize transmissions such that the AP is not transmitting a data frame when it is expecting an ACK frame from another station. This can be done by timing the multi-channel use such that transmissions of frames end about the same time so that independent recipients of those frames are likely to be silent until the transmission ends and are likely to follow with ACK frames about the same time.

If the AP's radios are 1) both idle, 2) sending data to multiple clients (or stations more generally) simultaneously, or 3) receiving data simultaneously, then signals are likely to be received correctly. One approach to achieving this condition for the bulk of the data sent from the AP to the clients is to have some time coordination of the transmissions across different radios.

In one approach, the data to be sent is arranged into frames that take the same amount of time to transmit and transmission starts at about the same time. Arranging frames to take the same amount of time can be done in a number of ways. For example, frames can be sorted so that similar duration frames are timed to be transmitted around the same time over different channels. Another approach is to use a fragmentation facility, such as the 802.11 fragmentation facility, to split long frames into shorter segments. Frames that are too short may be padded, or transmitted at a lower than possible data rate to extend the time it takes to send them.

Once the data is arranged into frames of equal lengths in time, these can be transmitted simultaneously. The AP might need to stop all other transmission on the channels it wants to send on, otherwise some other radio (perhaps one of the clients not aware of the special multi-channel synchronized burst coming) might be already transmitting on the channel when the AP started sending on all its channels. One facility for preventing this is the 802.11 NAV (Network Allocation Vector) facility used to reserve the wireless medium.

To set the NAV of all the clients, the AP schedules a frame to be sent on all the channels with the duration value set to enough time to allow the whole synchronized burst of data that is about to be sent. A “CTS-to-self” frame may be used for this purpose, or any other frame with a duration field. This frame is often called a protection frame. Once the protection frames have been successfully transmitted on all channels, the data transmissions can begin. Due to this requirement to set the NAV on all channels used by the AP the duration value used in the protection frame is preferably at least sufficient to cover the maximum time this is expected to take, if not to cover the entire burst. CTS-to-self may be preferred over some other protection frames due to its short length.

Alternatively, if all the radios in the AP detect carrier clear at the same time, then protection frames might not be needed and the burst can be started immediately on all channels.

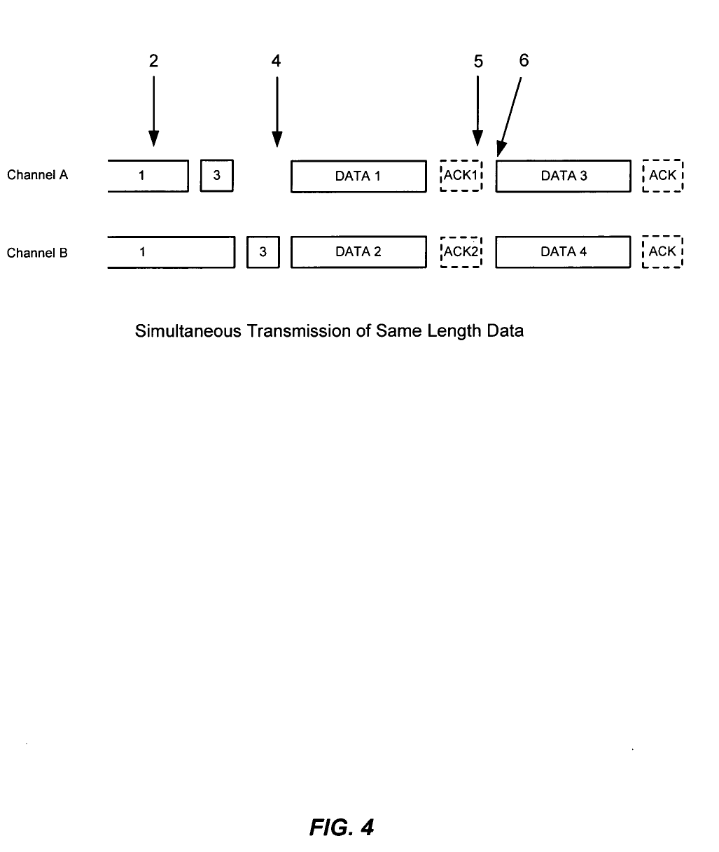

FIG. 4 is a timing diagram illustrating how some of the above processes might work. Due to sorting of the data (or another technique), the frames to be sent are in the same (or at least similar) length (in time) chunks. Now, while the AP is sending the data frames, it never has to transmit and receive on different channels at the same time, so in-band interference does not happen. With transmission successfully occurring on multiple channels at the same time, the data rate possible for data sent from the AP to the clients is increased in proportion to the number of radios used, less a small overhead for the time required to start the bursts, and possibly fragment the data to be sent.

The process of sorting of frames into same length (in time) fragments is not critical, as long as during the transmission burst the unicast frames (frames where an ACK is expected) are sent so that the frames end at the same time on all channels or approximately the same time. If the frames are not sorted into same size fragments, this results in unused airtime on some channels, since shorter frames must have their transmission delayed so that their transmission ends at the same time as other frames. The sorting and fragmenting process is an optimization to increase total airtime usage and throughput. While sorting and fragmenting can be expected to improve performance, they are not required.

As shown in FIG. 4, once existing transmissions end (1)—which can be synchronized or not—a CTS-to-self is scheduled (2) and sent on each channel (3) to be synched. Then synchronized frame transmission can start (4) without interference being expected. The ACK frames ACK1 and ACK2 can then be expected to be received (5) at a time when the AP is not transmitting, but just listening. Then, another set of frames can be transmitted (6). With each frame time being used for sending same or similar length frames, the multiple channels can be fully or nearly fully occupied without transmission interfering with reception.

As the frames in the synchronized burst are transmitted, the duration values in all the frames or fragments are set to ensure the NAV of any surrounding stations is set until the expected end of the whole multi-channel synchronized data burst.

An access point regularly transmits broadcast and multicast frames. In particular, an access point transmits regular beacon frames, and if any client station is in power-save mode, then all regular broadcast data frames are buffered by the access point and transmitted immediately after certain beacon frames. In an access point employing this multi-channel throughput enhancement, it is beneficial to use the burst transmission technique in order to transmit these regular beacons and buffered broadcast frames on all the channels at the same times. In order to do this, it is highly preferred that all the channels be reserved by the time the beacon transmission is required, so as to not unduly delay the beacon transmissions.

The use of the simultaneous burst for beacon transmission is particularly useful in access points that support multiple BSSs per radio (and hence transmit multiple beacons per radio).

If any channel is busy, it may take some time to access the channel in order to send the protection frame. In order to avoid wasting time on multiple channels, the protection frame can be sent with very high channel access priority. A PIFS channel access time or channel access such as AC_VO (voice access category) may be used. Since it may be a certain amount of time before the protection frame is transmitted on any channel (due to other transmissions in progress), all the channels should be reserved for a minimum length of time—long enough to ensure the protection frames can be sent on all the channels. This minimum time may be longer than the whole data burst duration, in which case a CF-End frame to reset the NAV may be sent at the end of the burst on all channels.

1. A wireless access point having an ability to transmit signals over a plurality of channels and receive signals over the plurality of channels, comprising:
means for synchronizing transmission on a first channel to a first station and transmission on a second channel to a second station, such that acknowledgements are not expected from at least one of the first and second stations while transmitting frames to at least one of the first and second stations;
means for transmitting over at least two of the plurality of channels simultaneously; and
means for receiving over at least two of the plurality of channels simultaneously.

2. The access point of claim 1, wherein the plurality of channels comprises three or more channels, thereby allowing simultaneous communication with three or more stations, wherein the means for synchronization is such that transmission on a channel is done while not expecting acknowledgements on any of the other channels.

3. The access point of claim 1, wherein synchronization is performed by starting transmission on a first channel and a second channel at the same time or within a predetermined short time period.

4. The access point of claim 1, wherein synchronization is performed by ending transmission when an immediate response is expected on a first channel and a second channel at the same time or within a predetermined short time period.

5. The access point of claim 1, wherein synchronization is performed by organizing frames to be of similar duration and beginning transmission at approximately the same time, so that transmissions end at the same time or within a predetermined short time period.

6. The access point of claim 5, wherein organizing frames to be of similar duration is performed by breaking up packets as needed to get similar sized frames.

7. The access point of claim 6, wherein the breaking up of packets is done using an 802.11 fragmentation facility.

8. The access point of claim 5, wherein organizing frames to be of similar duration is performed by padding short packets as needed to get similar duration frames.

9. The access point of claim 5, wherein synchronization is done by using lower than necessary data rates so that transmissions end at the same time or within a predetermined short time period.

10. The access point of claim 5, wherein organizing frames is done by sorting frames out of a default transmission order.

11. The access point of claim 1, further comprising NAV logic to use NAV on multiple channels where there is data to be sent, to clear the multiple channels for transmission.

12. The access point of claim 11, wherein the NAV logic uses CTS-to-self signals to clear channels.

13. The access point of claim 12, wherein the CTS-to-self signals are sent with a high priority.

14. The access point of claim 11, wherein the NAV logic uses a duration field in a frame to clear channels, keep channels clear during a burst or both.

15. The access point of claim 1, further comprising means for extending carrier sense to sense across a plurality of channels over which data is to be sent, to determine whether the sensed channels are all clear.

16. The access point of claim 15, further comprising NAV logic to use NAV on multiple channels where there is data to be sent, to clear the multiple channels for transmission, wherein the NAV logic uses a duration field in a frame to keep channels clear during a burst.

17. A wireless access point having an ability to transmit signals over a plurality of channels and receive signals over the plurality of channels, comprising:
means for synchronizing transmission on a first channel to a first station and transmission on a second channel to a second station, such that transmissions on either station are scheduled to avoid expected reception periods from at least one of the first and second stations while transmitting frames to at least one of the first and second stations;
means for transmitting over at least two of the plurality of channels simultaneously; and
means for receiving over at least two of the plurality of channels simultaneously.

18. The access point of claim 17, wherein the expected reception periods are periods in which the wireless access point expects to receive acknowledgements from at least one of the first and second stations.
